(19) United States
(12) Patent Application Publication
(10) Pub. No.: US 2009/0047022 A1
(43) Pub. Date: Feb. 19, 2009

(54) Remote Control Device

(76) Inventors: Kent David Newman, Hurst, TX (US); Rex Alan Holloway, North Richland Hills, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/838,455

(22) Filed: Aug. 14, 2007

(51) Int. Cl. H04B 10/00; H04R 3/00

(52) U.S. Cl. 398/106; 381/110

(57) ABSTRACT

A remote control device for wirelessly controlling a second device is disclosed that allows the user to remotely control the second device using spoken commands. The remote control device is preferably dimensioned to be useful as a handheld device. The remote control device includes one or more microphones into which the user can speak a command. The remote control device also includes a transmitter, for example a radio frequency transmitter and/or an optical transmitter, for transmitting a signal to the second device based on the user's spoken command.

### TECHNICAL FIELD

This invention relates to remote control devices, particularly handheld devices that allow for remote, wireless operation of another system or device.

### BACKGROUND

Remote control devices for remotely and wirelessly controlling various appliances have been widely available for a number of years. For example, remote control devices are available for controlling televisions, digital video disc (DVD) players, television and stereo receivers, and even ceiling fans. A typical remote control device includes several buttons and a transmitter for wirelessly transmitting signals as the buttons are pressed. Common methods of wireless transmission include the use of optical (e.g., infrared) signals and radio frequency (rf) signals.

In the automotive industry, remote control devices are available for locking and unlocking doors, activating and deactivating car alarms, remotely starting the vehicle, and controlling a car stereo. Some automotive systems can also be controlled using voice commands. For example, some cars are now available with in-dash navigation systems that can respond to a predefined list of voice commands.

In one such system, a driver first presses a “voice” button located on the cars center console or steering wheel. In response, the navigation system issues a voice prompt instructing the driver to say the desired command. The driver can then say any one of a number of predefined voice commands. A microphone built into the navigation system receives the spoken command as an acoustic input signal and converts the acoustic input signal to electrical signals, which are passed on to other components of the navigation system for processing. If the voice command is recognized by the navigation system, then the navigation system performs a predefined function associated with the voice command. However, the voice command may not be recognized for a number of reasons. For example, inclement weather or rough driving conditions can cause ambient noise that interferes with the microphone's ability to receive the voice command. Since the microphone is fixed in place, the driver does not have the option of re-positioning the microphone to a better location, so voice commands cannot be used. Since it is often more difficult to drive in bad weather or otherwise rough conditions, the convenience of voice commands is lost during at times when it may most be needed.

### BRIEF DESCRIPTION OF THE DRAWINGS

Embodiments are illustrated by way of example in the accompanying figures, in which like reference numbers indicate similar parts, and in which:

FIGS. 1 and 2 show a car interior in which the presently disclosed remote control device is employed;

FIG. 3 shows a block diagram illustrating various devices and signal types that can be associated with the present remote control device;

FIG. 4 shows a front-top perspective view of an embodiment of the remote control device;

FIG. 5 shows a front-bottom perspective view of the remote control device shown in FIG. 4;

FIG. 6 shows a partial side-view of an embodiment of the remote control device;

FIG. 7 shows a partial side-view of an embodiment of the remote control device;

FIGS. 8a and 8b show partial side-views of an embodiment of the remote control device;

FIG. 9 shows front-top perspective view of an embodiment of the remote control device;

FIG. 10 shows a functional block diagram of an embodiment of the remote control device; and

FIG. 11 shows a functional block diagram of an embodiment of a navigational device that can be remotely and wirelessly controlled by the remote control device.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

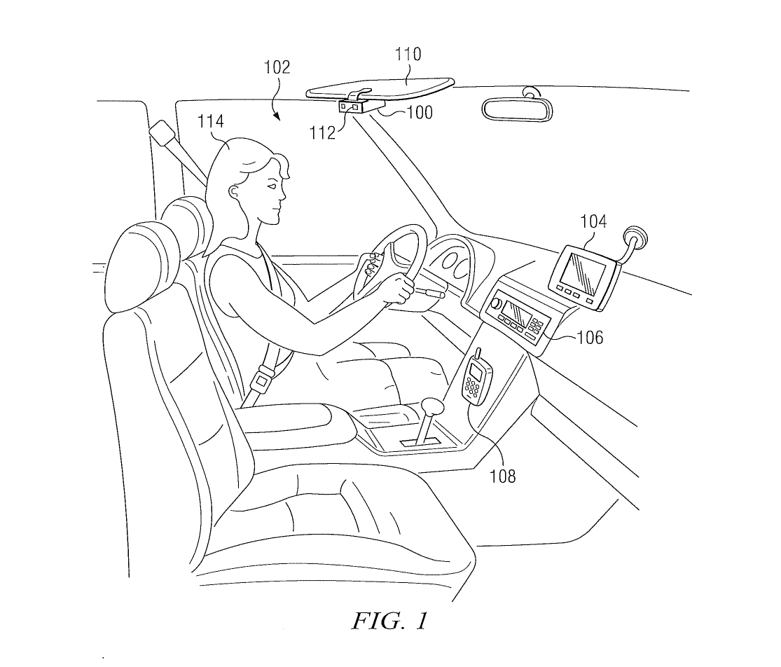

Referring initially to FIG. 1, a wireless remote control device 100 is shown employed in an automobile interior 102. Also located in the automobile interior 102 are a variety of electronic devices and systems, for example a navigation system 104, a car stereo 106, and a mobile telephone 108. The remote control device 100 can be configured to wirelessly operate one or more of these and other devices and systems located in the automobile interior 102 or otherwise associated with the automobile. The remote control device 100 can also or alternatively be configured to wirelessly operate systems not shown, such as door locks, door/hatch/trunk/sunroof opening systems, environmental control systems, onboard computer systems such as those that provide information regarding vehicle status (distance to empty fuel tank, indoor/outdoor temperature, compass heading, odometer reading, mileage, and/or other information), security systems, entertainment systems, remote-start systems, and even systems not directly associated with the automobile such as gate or garage-door opening systems and residential lighting controls.

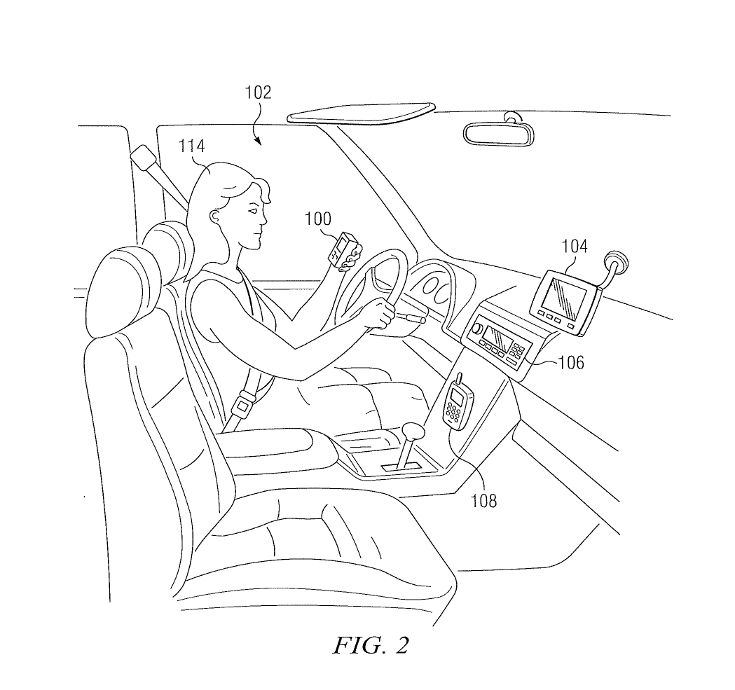

As will be described in greater detail below, the remote control device 100 can receive spoken commands as acoustic input signals and transmit wireless signals based on the received spoken commands. The remote control device 100 is preferably dimensioned to be a handheld device that can be conveniently located and repositioned as desired by the user. For example, in FIG. 1 the remote control device 100 is removably clipped to the driver's visor 110. It should be appreciated that there are a number of locations and mounting methods, removable or otherwise, that a user may opt to employ other than clipping to a visor. The remote control device 100 includes a microphone 112 that can be generally directed towards the driver 114 for receiving spoken commands in the form of acoustic signals. Turning to FIG. 2, the driver 114 can opt to remove the remote control device 100 from the visor 110 (or other location) and hold it in-hand while speaking commands or otherwise operating the remote control device 100. This can be particularly convenient in a noisy environment, for example during inclement weather, because the user can hold the remote control device 100 closer to allow for better reception of spoken commands.

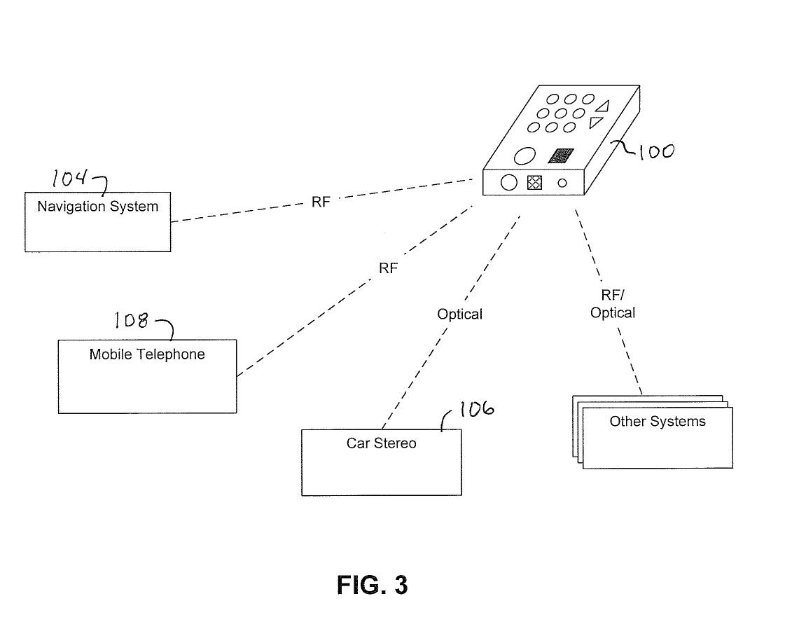

Turning next to FIG. 3, wireless transmissions from the remote control device 100 can vary depending on the specific device being wirelessly operated. For example, the navigation system 104 may be configured for remote operation by a first radio frequency (rf) signal, the mobile phone may be configured for remote operation by a second rf signal, and the car stereo may be configured for remote operation by an optical signal such as an infrared signal. The user can select one of the systems 104/106/108 to operate using the remote control device 100, input a command (spoken or otherwise), and in response the remote control device 100 will output a wireless signal as appropriate for the selected system 104/106/108. In some embodiments, the remote control device 100 can be configured to operate only one specific device or system rather than two or more different devices and/or systems. Examples of rf signals can include radio signals at or near 46 MHz (for example in a range of 43 MHz to 50 MHz), 900 MHz (for example in a range of 900 MHz to 928 MHz), 1.9 GHz (for example in a range of 1.9 GHz to 1.95 GHz), 2.4 GHz (for example in a range of 2.4 GHz to 2.5 GHz), or 5.8 GHz (for example in a range of 5.7 GHz to 5.9 GHz). Examples of optical signals can include infrared signals, for example emitted from an infrared or near-infrared light emitting diode (LED).

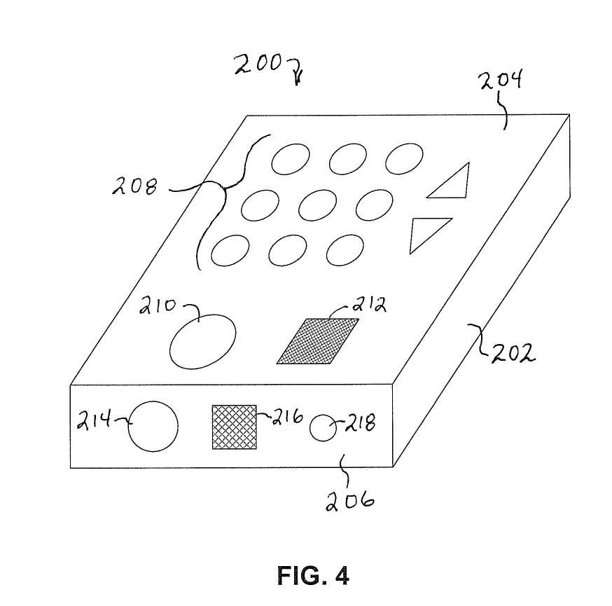

Turning next to FIG. 4, a front-top perspective view is shown of a remote control device 200, which is an embodiment of the remote control device 100 described above. The remote control device 200 includes a housing 202 having a front face 204 and an end face 206. The housing 202 is preferably formed of a rigid material, for example a rigid plastic or metal. In this embodiment, the front face 204 includes a plurality of function buttons 208. The function buttons 208 can include any number of a variety of different buttons, each of which may be associated with specific inputs, operations, functions, or macros, which can vary depending on the types of systems the remote control device 100 is configured to operate. In some embodiments, the remote control device 100 can be used to control multiple different devices, and the buttons 208 can include In some embodiments the function buttons 208 can be programmable buttons such that the user can program the buttons 208 to be associated with certain desired functions. A first voice button 210 and a first microphone 212 are both located on the front face 204 of the remote control device 200. A second voice button 214 and a second microphone 216 are both located on the end face 206 of the remote control device 200. An optical signal transmitter 218, for example an infrared or near-infrared LED, is also located on the end face 206 of the remote control device 200.

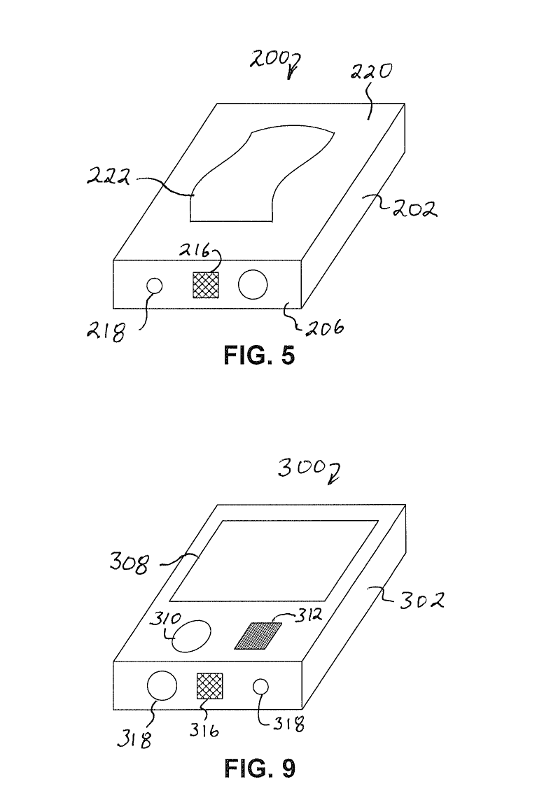

Turning next to FIG. 5, a front-bottom perspective view is shown of the remote control device 200 shown in FIG. 4. As shown in FIG. 5, the housing 202 of the remote control device 200 also includes a back face 220. In the illustrated embodiment, a visor clip 222 is attached to the back face 220 of the remote control device 200. In some embodiments, the visor clip 222 can be removably attached to the back face 220, for example the visor clip 222 can be configured to snap or slide into place on the back face 220. In some embodiments, the visor clip 222 can be more permanently attached to the remote control device 200, for example the visor clip 222 can be screwed or glued to the remote control device 200.

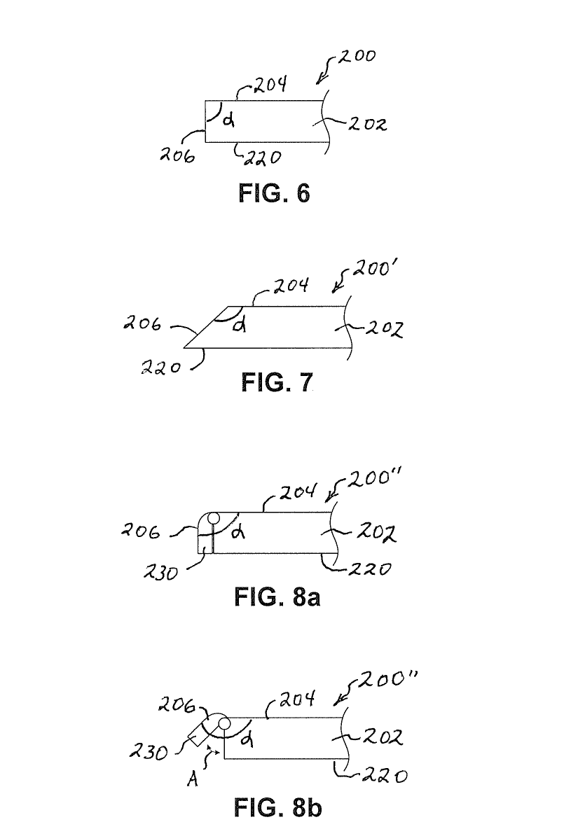

Turning next to FIG. 6, which shows a partial side view of the remote control device 200. As shown in FIG. 6, the angle α is a right angle (90 degrees) between the end face 206, on which the second microphone 216 is located, and the front face 204, on which the first microphone 212 is located. Thus, the first microphone 212 faces a first direction and the second microphone 216 faces a second direction, wherein the first direction is at a right angle to the second direction. In alternative embodiments, the remote control device 200 can include only a single microphone that is located on the end face 206 or on the front face 204 or in some other location.

In alternative embodiments, the angle α between the front face 204 and the end face 206 can be any angle. For example, FIG. 7 shows an alternative embodiment as remote control device 200′ where the angle α between the front face 204 and the end face 206 is between 90 degrees and 180 degrees. Like the remote control device 200, in some embodiments the remote control device 200′ can include a first microphone 212 on the front face 204 and a second microphone on the end face 206, in which case the angle α is also the angle between the directions faced by the first and second microphones 212 and 216. In other embodiments, the remote control device 200′ can include only a single microphone that is located on the end face 206 or on the front face 204 or in some other location.

Turning next to FIGS. 8A and 8B, in still further embodiments the remote control device can be configured such that the angle α between the front face 204 and the end face 206 can be adjusted by the user. For example, in the alternative embodiment shown as remote control device 200″, the end face 206 is provided on and end piece 230 that is attached to the housing 202 via a hinge 232. The hinge 232 allows the end piece 230 to move relative to the housing 202 in the directions indicated by arrow A in FIG. 8B, for example allowing the user to move the end piece 230 between the position shown in FIG. 8A and the position shown in FIG. 8B, thereby adjusting the angle α between the front face 204 and the end face 206. Like the remote control device 200, in some embodiments the remote control device 200″ can include a first microphone 212 on the front face 204 and a second microphone on the end face 206, in which case the angle α is also the angle between the directions faced by the first and second microphones 212 and 216. In such embodiments, the user can therefore adjust the angle α between the directions faced by the first and second microphones 212 and 216. In other embodiments, the remote control device 200″ can include only a single microphone that is located on the end face 206 or on the front face 204 or in some other location.

Turning next to FIG. 9, a second embodiment is shown as remote control device 300. Similar to the remote control device 200, the remote control device 300 includes a housing 302, a front face 304, and an end face 306. Also like the remote control device 200, the remote control device 300 includes a first voice button 310 and a first microphone 312 on the front face 304, and includes a second voice button 314, a second microphone 316, and an optical signal transmitter 318 on the end face 306. The remote control device 300 differs from the remote control 200 in that the remote control device 300 has a combination display and touch screen 308 rather than function buttons. Alternative embodiments can include any combination of a display, touch screen, buttons, or other types of user input elements. Also, embodiments of the remote control device 300 can include any of the housing embodiments shown in FIGS. 6-8.

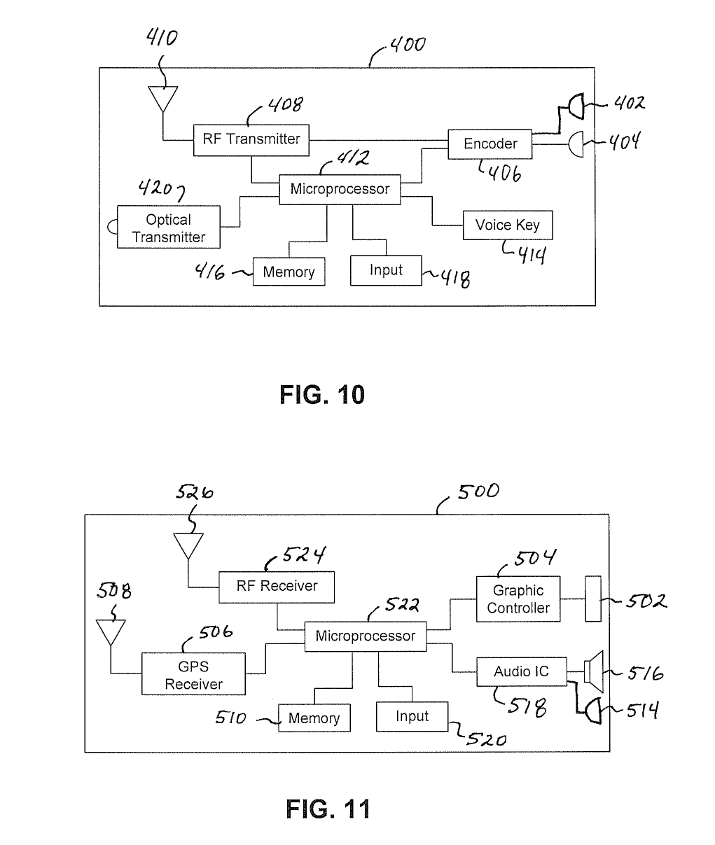

Turning next to FIG. 10, a functional block diagram is shown of a remote control device 400. The functional block diagram shown in FIG. 10 can be implemented in any of the remote control devices 200, 200′, 200″, and 300 described above. The remote control device 400 includes a first microphone 402 and optionally includes a second microphone 404. Each microphone 402 and 404 preferably includes a noise canceling directional microphone designed to eliminate ambient noise. For example, in preferred embodiments the microphone 402 comprises two microphone elements, wherein the input to one of the two microphone elements is used to filter the input to the other of the two microphone elements. In preferred embodiments that also include the optional second microphone 404, the second microphone 404 also comprises two microphone elements, wherein the input to one of the two microphone elements is used to filter the input to the other of the two microphone elements.

The output from the microphone 402, and from the microphone 404 if present, is provided to an encoder 406. The encoder 406 converts the output from the microphone(s) into electrical signals, which are provided to an RF transmitter 408 for wireless transmission via antenna 410. Note that the antenna 410 may be internal to the remote control device 400 in some embodiments, and may be external to the remote control device 400 in other embodiments. A microprocessor 412 controls the function and timing of the various components of the remote control device 400. For example, the microprocessor 412 can be configured to inhibit transmission of output from the microphone(s) unless a voice key 414 has first been pressed by a user. The microprocessor 412 has access to an electronic memory 416, which can store program instructions for the operation of the microprocessor 412. The microprocessor 412 can also reacts to user input from input 418, which can include a keypad, a touch screen, or any other type of user input device. User input via input 418 can include input of a command for a wirelessly remote device. The microprocessor 412 can detect the input and control the output of an associated optical signal from optical transmitter 420. The optical transmitter 420 preferably includes an infrared or near-infrared LED for transmitting optical signals, however other types of lighting elements can be used in alternative embodiments. In preferred embodiments, the remote control device 400 is configured to include a power supply 424, for example where the power supply 424 includes a battery compartment for a battery suitable for supplying electrical power for operation of the remote control device 400.

In some embodiments, the user can remotely control another device, for example a navigation system or a car stereo, using voice commands with the remote control device 400. The user begins by momentarily pressing the voice key 414, then saying the command. In some embodiments, the voice key 414 may instead be configured such that a user must hold down the voice key 414 while saying the command. In some embodiments, the voice key 414 can provide feedback to the user indicating that the remote control device 400 is ready to receive a voice command. For example, the voice key 414 can include a lighting element, such as an LED, for emitting a light for a predetermined amount of time after the voice key 414 has been pressed, during which time the remote control device 400 can receive spoken commands for remotely controlling another device. Once the user presses the voice key 414, the microprocessor 412 receives an input from the voice key 414 indicating that the voice key 414 has been pressed. The microprocessor then enables the appropriate subsystems, such as the encoder 406 and the transmitter 408, so that a wireless signal will be transmitted based on the spoken command. In some embodiments, the spoken command is received by the microphone 402 or 404 as an acoustic signal, which is converted to a digital signal representative of the acoustic signal, and then the transmitter 408 transmits an RF signal representative of the received sounds. In alternative embodiments, the remote control device 400 can include speech recognition software, for example stored in the memory 416, that allows the microprocessor 412 to detect certain words and phrases in the acoustic signal received by the microphones 402 and 404. In such embodiments, if the microprocessor 412 recognizes a command in the received acoustic signal, the microprocessor 412 can then send a signal to the RF Transmitter 408 and/or to the optical transmitter 420 for transmitting a command signal associated with the recognized speech.

Turning next to FIG. 11, a functional block diagram is shown of a navigation device 500, which serves as an example of a remote device that can be controlled by the remote control device described herein. It should be appreciated that concepts described in connection with the functional block diagram shown in FIG. 11 can be applied to systems other than navigation devices. The navigation device 500 can include conventional elements commonly associated with known navigation devices. In the embodiment show, the navigation device 500 includes a display 502, such as a liquid crystal display; a graphic controller 504 for driving the display 502; a global positioning system (GPS) receiver 506 and GPS antenna 508 (note that the antenna 508 may be internal to the navigation device 500 in some embodiments, and may be external to the navigation device 500 in other embodiments); a memory 510 for storing information for operation of the navigation device 500, for example navigation software and data for maps, points of interest, contacts, and/or other data; a microphone 514; a speaker 516; a codec 518 for encoding signals from the microphone 514 and decoding signals for output through the speaker 516; input 520, which is representative of various types of elements that allow for user input, such as buttons, knobs, and/or touch-screen controls; and a microprocessor 522 for controlling overall operation of the various components of the navigation device 500.

The navigation device 500 can be remotely controlled by incoming wireless RF signal. The navigation device includes an RF receiver 524 for receiving the wireless RF signals via an antenna 526. Note that the antenna 526 may be internal to the navigation device 500 in some embodiments, and may be external to the navigation device 500 in other embodiments.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

What is claimed is:

1. A remote control device for wirelessly controlling a second device, comprising:
a housing having non-coplanar first and second outer surfaces;
a first microphone disposed within the housing adjacent to the first outer surface;
a plurality of user input keys, supported by the housing, operable by a user, and including command keys that are associated with respective operations of the second device;
a radio frequency transmitter, disposed within the housing, operable to transmit radio signals based on spoken commands received as acoustic signals by the first microphone;
an optical transmitter, supported by the housing, operable to transmit optical signals based on user operation of the command keys; and
a microprocessor, disposed within the housing, operably connected to the first microphone, the plurality of command keys, the radio frequency transmitter, and the optical transmitter;
wherein the radio signals are generated by the radio frequency transmitter such that the radio signals can be wirelessly transmitted from the remote control device, wirelessly received by the second device, and cause the navigation device to perform predetermined actions associated with the spoken commands.

2. The device according to claim 1, further comprising a second microphone disposed within the housing adjacent to the second outer surface.

3. The device according to claim 2, wherein the radio frequency transmitter is further operable to transmit radio signals based on spoken commands received as acoustic signals by the second microphone.

4. The device according to claim 2, wherein the first and second microphones are directional microphones.

5. The device according to claim 4, wherein the first and second microphones are configured to receive acoustic signals from first and second different directions, respectively.

6. The device according to claim 2, wherein the first and second microphones are noise-canceling microphones, each of the first and second microphones comprising at least two microphone elements.

7. The device according to claim 1, wherein the plurality of user input keys includes a voice key operable by the user to cause the microprocessor to enable the radio frequency transmitter to transmit the radio signals based on spoken commands.

8. The device according to claim 1, further comprising a battery compartment, supported by the housing, configured to support at least one battery such that the at least one battery can provide electrical power for operation of the remote control device.

9. The device according to claim 1, wherein the command keys that are associated with respective operations of the second device includes graphics displayed on a touch screen.

10. A remote control device for wirelessly controlling a second device, comprising:
a housing having non-coplanar first and second outer surfaces;
a first microphone disposed within the housing adjacent to the first outer surface;
a second microphone disposed within the housing adjacent to the second outer surface;
a radio frequency transmitter, disposed within the housing, operable to transmit radio signals based on spoken commands received as acoustic signals by the first or second microphone; and
a microprocessor, disposed within the housing, operably connected to the first microphone, the second microphone, and the radio frequency transmitter;
wherein the radio signals are generated by the radio frequency transmitter such that the radio signals can be wirelessly transmitted from the remote control device, wirelessly received by the second device, and cause the navigation device to perform predetermined actions associated with the spoken commands.

11. The device according to claim 10, wherein the first microphone is a directional microphone facing a first direction, and the second microphone is a directional microphone facing a second direction that is different from the first direction.

12. The device according to claim 11, wherein the second direction is angularly displaced from the first direction by an angle in a range of 90 degrees to 180 degrees.

13. The device according to claim 12, wherein the second direction is angularly displaced from the first direction by an angle of 90 degrees.

14. The device according to claim 10, wherein the first and second microphones are noise-canceling microphones, each of the first and second microphones comprising at least two microphone elements.

15. The device according to claim 10, further comprising a plurality of user input keys, disposed on the first outer surface of the housing, operable by a user, and including command keys that are associated with respective operations of the second device.

16. The device according to claim 15, further comprising an optical transmitter, supported by the housing, operable to transmit optical signals based on user operation of the command keys.
